(19) United States
(12) Patent Application Publication
(10) Pub. No.: US 2011/0090563 A1
(43) Pub. Date: Apr. 21, 2011

(54) UNIFORMITY IN SLIDE SCANNING

(75) Inventor: Yuri Krasov, Castro Valley, CA (US)

(73) Assignee: Molecular Devices, Inc., Sunnyvale, CA (US)

(21) Appl. No.: 12/937,228

(22) PCT Filed: Apr. 10, 2009
(86) PCT No.: PCT/US09/40236

§ 371 Date: Dec. 16, 2010

Related U.S. Application Data
(60) Provisional application No. 61/044,455, filed on Apr. 11, 2008.

(51) Int. Cl. G02B 21/26

(52) U.S. Cl. 359/391

(57) ABSTRACT

A sample slide stage includes at least four fixed members that are arranged at, or about at, a focal plane of the slide stage, and are configured to receive a slide; and a plurality of compression members that apply a controlled force to compress a slide towards the fixed members at the focal plane, whereby a surface of a non-planar slide in the sample stage is deformed towards the focal plane. Methods of deforming non-planar slides towards a focal plane include inserting a non-planar slide into a sample slide stage that has at least four fixed members arranged at or about at a focal plane; and applying a controlled force to compress the non-planar slide to the fixed members at the focal plane, whereby a surface of the non-planar slide is deformed towards the focal plane.

### RELATED APPLICATIONS

This application claims priority from Provisional Patent Application No. 61/044,455, filed on Apr. 11, 2008, the contents of which are incorporated herein by reference in their entirety.

### TECHNICAL FIELD

This invention relates to scanning of slides, and more particularly to improving uniformity in scanning of slides.

### BACKGROUND

Scanning of biological samples, e.g., microarray slides, typically involves scanning the slide in two dimensions. For example, a slide mounted in a slide holder of an optical scanning stage can be moved relative to each other by a Y-axis translation stage, which can advance a step for each line scanned in an X-axis translation stage. The optical scanning stage can direct light, e.g., from a laser, to a sample slide, which can illuminate the sample. The optical scanning head can collect light from the sample at the slide, for example, fluorescence light emitted by fluorescently labeled DNA material that is excited by the illuminating light, and can direct the light to a detector, such as a photomultiplier tube. The signal acquired at the detector can be processed and analyzed by software, for example, by constructing a corresponding image based on pixel coordinates and signal intensity.

An important parameter in this process is field uniformity, the ability of the scanner to collect emission light uniformly across the scanned area of the sample 1″×3″×1 mm slide (field uniformity of the image). Field uniformity thus directly depends on the position of the sample surface of the slide surface compared to a focal plane of the illuminating light and detector. As the slide and the optical scanning head move with respect to each other along the X and Y axes, any deviations of the sample surface of the slide along the Z axis, i.e., into or out of the focal plane, result in a decreased signal according to the deviations. For example, in one recent instrument, a deviation from the focal plane within range of +/−5 micrometers can result in an intensity deviation of about +/−5%. Thus, an ideal slide would be perfectly flat across the area to be scanned.

However, most slides used in practice deviate significantly from flatness by typically tens or even hundreds of micrometers, and even slides promoted as “optically flat” can typically deviate from flatness by tens of micrometers. Moreover, for reasons of economy and experimental flexibility, many users desire to use cheap mass-produced glass slides, or custom slides made in the lab of other materials such as semiconductors, polymers, and the like, all of which may have significant deviations from flatness. During scanning, this deviation from planarity results in substantial defocusing and non-uniformity of the image intensity. Both defocusing and non-uniformity are detrimental for scanner performance.

FIG. 1 is an exemplary graph of a typical focusing curve of a scanner shown as variation of the normalized emission intensity versus position of the imaged portion of the slide surface with respect to the focal plane. The scanner used was a GenePix® GP4400A Scanner (MDS Analytical Technologies, Sunnyvale Calif.). Scanning of a slide in the GenePix® GP4400A Scanner is accomplished by moving a slide mounted in a slide stage, attached to a Y-axis translation stage. The Y-stage steps (advances) once per line scanned by an optical stage in the X-direction. The optical stage directs focused laser light (excitation) to the bottom of the slide with labeled DNA material. The optical stage also collects fluorescent light emitted by a dye attached to the DNA material and directs it to a detector (a photomultiplier tube). Depending on the setting of the scanning resolution, the Y-axis translation stage can advance at 2.5, 5, 10, or 20 micrometers for each step. The optical stage can scan at a constant speed, but the dwell time per pixel depends on the resolution setting. The optical signal data thus obtained that can be processed by software and the resulting image can be restored based on pixel coordinates and signal intensity.

In FIG. 1, an exemplary graph of a typical focusing curve of a scanner is shown as variation of the normalized emission intensity versus position of the imaged portion of the slide surface with respect to the focal plane. It is clear from the graph that if the slide surface deviates (defocuses) from the focal plane, there is a decrease in signal. For example within a range of +/−5% micrometers, the intensity deviates within the range of about +/−5% from maximum. Even a deviation of less than about 1 micrometer would likely lead to a reproducible change in signal intensity.

In one known example, the defocusing resulting from deviations from the focal plane was addressed by improving parameters of the Y-axis translation stage. For example, pitch and roll of the stage movement was reduced, e.g., to +/−2.5 micrometers. Also, a ball slide that moves the optical stage along the X-axis has a combined pitch and roll within about +/−2.5 micrometers. FIG. 2 shows a prior art slide stage 100, which includes three sapphire balls 104, each having a diameter of about 1/32″, which are incorporated into the slide stage 100, and which define a scanning plane. When the cover 105 of slide stage 100 is closed by operating hinge 106, three pins 102 with conical rubber tips contact one side of a slide, securing it against the three sapphire balls 104. This enables slide registration on three points along the Z-axis (vertically). It also helps to secure a slide in the holder from inadvertent X and Y-axis movements.

During factory alignment (focusing) the slide stage 100 is aligned to position the surface of the slide as close as possible to the laser focal plane. Slide stage 100 has adjustment features that can move a slide vertically (along Z-axis) and can adjust for tilt of the slide with respect to the focal plane. During the focusing process a test slide can be used, which is uniformly coated with fluorescent material and is within 1-3 μm of planarity. While this test slide is scanned, the position of the slide stage is adjusted to maximize the intensity of the signal on the top, center, and bottom of the slide. This ensures that the scanning plan defined by balls 104 places the test slide coincident with the focal plane of the scanner.

However, slide stage 100 does not address the issues that arise with non-planar slides, as indicated in FIGS. 3A and 3B. For example, FIG. 3A is a perspective view that shows that non-planar slide 110, although held by points 102 and balls 104, deviates from focal plane 108. FIG. 3B shows a side-view of the features outlined in FIG. 3A, showing the deviation 112 between a surface of non-planar slide 110 and focal plane 108. Typical slide imperfections can result in a slide being “bowed” along its short axis (see FIG. 3A) or twisted along its long axis (like a plane's propeller).

Various strategies are available to move the slide to the focal plane or otherwise provide for dynamic autofocusing of the illuminating light and/or the detector. However, such strategies can involve a mechanical system that adjusts slide position to compensate for this deviation, additional optics to measure deviation of the slide surface from the focal plane during scanning, and associated control circuitry, which can increase cost and can require additional service and calibration. In addition, attempts to resolve the issue have also resulted in systems that can crack the sample slides.

Consequently, there is a need for an economical and effective apparatus and methods to improve field uniformity at the focal plane of such optical scanners.

### SUMMARY

The invention is based, at least in part, on the discovery that if one arranges at least four, and more preferably six or more, fixed members on a slide stage support frame at about the stage's focal plane, and then uses at least four, and more preferably six or more, compression members to apply a controlled force to the surface of a non-planar slide, that the slide can be securely held between the compression members and the fixed members and actually deformed from a twisted or bowed non-planar state towards the focal plane without cracking the slide. The new slide stages and methods, when used in slide scanners, such as DNA microarray or gene chip microarray scanners, thus improve uniformity in scanning of slides in an effective and economical manner.

In one aspect, the invention features a slide stage that includes at least four fixed members arranged at about a focal plane of the stage and configured to receive a slide; and a plurality of at least about four compression members that are arranged to apply a controlled force to a surface of a slide towards the fixed members at the focal plane, whereby a surface of a non-planar slide in the slide stage is deformed towards the focal plane. In certain embodiments, each compression member applies a controlled force of at least about 2 to about 7 Newtons, and the compression member can be, or include, a spring, an elastic bumper, an electromagnetic actuator, a piezoelectric actuator, a worm drive, a stepper motor, a solenoid, a magnetic actuator, a pneumatic actuator, or a hydraulic actuator.

The slide stages can further include first and second rigid support frames, wherein the fixed members are arranged on the first support frame and the compression members are arranged on the second support frame, and wherein the first and second rigid support frames are arranged to operate together to define a slide receiver in the slide stage that opens to receive a slide and closes to compress a slide. For example, the first and second support frames can be hinged together.

In another embodiment, the new slide stages further include first, second, and third rigid support frames, wherein the fixed members are arranged on the first support frame and groups of the compression members are arranged on the second and third support frames, and wherein the second and third rigid support frames are arranged to operate together with the first support frame to define a slide receiver in the slide stage that opens to receive a slide and closes to compress a slide. For example, the second and third support frames can each be hinged to the first support frame.

In certain embodiments, each fixed member is axially aligned with one corresponding compression member, e.g., a spring-loaded compression member. In some embodiments, the slide stages can include between six and eight fixed members, and one or more of the fixed members can be adjustable with respect to the focal plane. In certain embodiments, the compression members are arranged to apply a controlled force that deforms a surface of a non-planar slide towards the focal plane by at least about 5 micrometers.

In some embodiments, a first rigid support, including the fixed members, is hinged to second and third rigid supports which include the compression members. In certain embodiments, each fixed member is opposed at a slide compressed in the slide receiver by one corresponding spring-loaded compression member. In general, at least one of four and, e.g., three of six, compression members is adjustable to enable the compression members to be adjusted to the focal plane in spite of manufacturing irregularities of the rigid supports or frames to which the compression members are secured.

In various embodiments, each fixed member has a contact surface area at the focal plane of less than about 1 square millimeter. Typically, each fixed member is a point contact or a ball contact. In various embodiments, the sample stage includes between four and thirty fixed members, or in some embodiments between six and eight fixed members. In certain embodiments, one or more of the fixed members is adjustable with respect to the focal plane.

The sample stage can be configured to receive typical microscope slides. For example, the sample stage can be configured to receive a slide having dimensions of about 25 millimeters wide by about 75 millimeters long by about 0.7 millimeters to about 1.4 millimeters thick.

In some embodiments, a surface of a non-planar slide is deformed towards the focal plane by at least about 1 micrometer, at least about 5 micrometers, at least about 10 micrometers, or at least about 15 micrometers.

In various embodiments, the slide stage can be configured as a slide feeder drawer, wherein the second and third rigid supports are coupled by a driver rod to a cam mechanism, wherein inserting the slide stage into a receiving bay operates the cam mechanism and the driver rod to close the second and third rigid supports, and withdrawing the slide stage from the receiving bay operates the cam mechanism and the driver rod to open the second and third rigid supports. In some embodiments, a motor is coupled to the cam mechanism to automatically open and close the second and third rigid supports.

In some embodiments, a slide stage includes a first rigid support having at least six fixed members at a focal plane, wherein each fixed member is a point contact or a ball contact. Also included is a second rigid support and a third rigid support, each hinged to the first support, the hinged rigid supports together defining a slide receiver that opens to receive a slide and closes to compress a slide. Further, for each fixed member, a corresponding spring-loaded compression member is located at the second rigid support or the third rigid support so that each fixed member is opposed at a slide compressed in the slide receiver by one corresponding spring-loaded compression member. Thus, a surface of a non-planar slide is deformed towards the focal plane.

In another aspect, the invention features methods of deforming a non-planar slide towards a focal plane. The methods include inserting a non-planar slide into a slide stage that includes at least four fixed members that are arranged at about a focal plane of the slide stage; and applying a controlled force to at least four points on a surface of the non-planar slide to compress the slide towards the fixed members at the focal plane, whereby a surface of the non-planar slide is deformed towards the focal plane.

In these methods, the controlled force can be at least about 2 to 7 Newtons, and the controlled force can be applied with a spring, an elastic bumper, an electromagnetic actuator, a piezoelectric actuator, a worm drive, a stepper motor, a solenoid, a magnetic actuator, a pneumatic actuator, or a hydraulic actuator. In some embodiments, the sample stage can include between six and eight fixed members, and the methods can further include adjusting one or more of the fixed members with respect to the focal plane.

Some embodiments of the methods include adjusting one or more of the fixed members with respect to the focal plane. In certain embodiments, the force is applied to the slide at locations opposite to at least one of the fixed members, typically at locations opposite to each of the fixed members.

In various embodiments of the methods of deforming a slide to a focal plane, a surface of a non-planar slide is deformed towards the focal plane by at least about 1 micrometer, at least about 5 micrometers, at least about 10 micrometers, or at least about 15 micrometers.

In another aspect, the invention features scanning systems that include the new sample slide stages described herein, and methods of using such scanning systems. For example, such scanning systems can be scanning microscopes and microarray scanners, such as an MDS Analytical Technologies GenePix® 4000B microarray scanner, which can be used for the acquisition and analysis of expression data from DNA microarrays, protein microarrays, tissue arrays, and cell arrays.

The slide stages and methods described herein are practical, economical, and effective in improving field uniformity at the focal plane of optical scanners, such as in microarray gene chip scanners or any scanners of slides, such as glass slides. The invention permits the use of non-planar slides such as mass-produced glass slides, or custom slides made in the lab of other materials such as semiconductors, polymers, and the like, all of which may have significant deviations from flatness. The invention improves field uniformity without resorting to actively moving the slide to the focal plane or autofocusing the illuminating light and/or the detector, thus avoiding the need for corresponding actuators or lenses and associated control circuitry, which can increase cost and can require additional service and calibration. Thus, scan performance can be effectively and economically improved.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### BRIEF DESCRIPTION OF THE DRAWINGS

FIG. 1 is a graph of a typical focusing curve of a scanner shown as a variation of the normalized emission intensity versus position of the imaged portion of the slide surface with respect to the focal plane.

FIG. 2 is a schematic diagram of a prior art slide stage 100. Three sapphire balls 104 act as slide contacts to define a scanning plane. Three pins 102 with rubber tips press down on the slide and register their tips on the sapphire balls 104. Each tip 102 is aligned with a corresponding ball 104. None of the pins are adjustable.

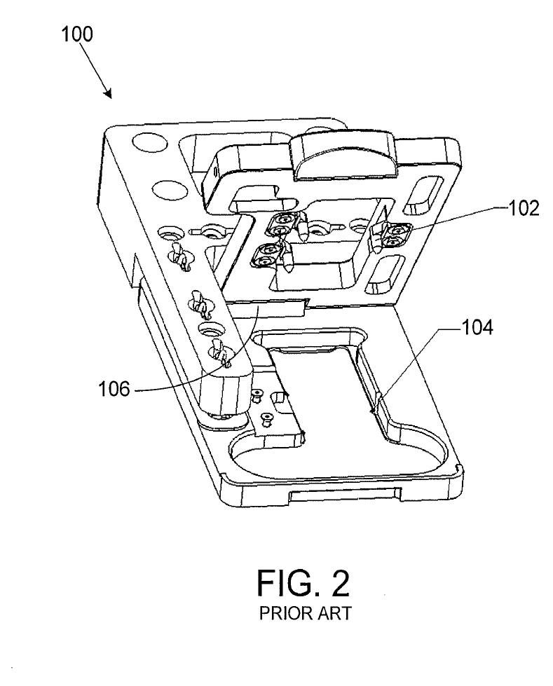

FIG. 3A is a perspective diagram regarding aspects of prior art slide stage 100, showing that non-planar slide 110, although held by points 102 and balls 104, deviates from focal plane 108 in a bowed configuration.

FIG. 3B is a schematic side view of the features outlined in FIG. 3A, showing the deviation 112 between a surface of non-planar slide 110 and focal plane 108.

FIG. 4A is a perspective diagram of slide stage 200, in an open configuration.

FIG. 4B is a side view of the disclosed slide stage 200 shown in FIG. 4A, but in a closed configuration.

FIG. 5A is a perspective diagram of aspects of a non-planar slide when compressed according to the disclosed slide stage. A non-planar slide 210 is held between compression members 202 and fixed members 204, thus deforming non-planar slide 210 towards focal plane 208.

FIG. 5B is a side view of FIG. 5A. A non-planar slide 210 is held between compression members 202 and fixed members 204, thus deforming non-planar slide 210 towards focal plane 208. The deviation 212 between focal plane 208 and compressed slide 210 is reduced compared to deviation 112 in FIG. 3B.

FIG. 6A is a perspective diagram of a sample stage 201, similar to sample stage 200, but configured as a slide feeder drawer, shown in a closed position, that compresses a slide 210 between compression members 202 and fixed members 204.

FIG. 6B is a perspective diagram of a sample stage 201 shown in FIG. 6A, wherein the second and third rigid support frames 214/215 are in an open configuration.

FIG. 7A is an interferometric image demonstrating the deviation from planarity of 3.65 micrometers of an unrestrained/uncompressed non-planar slide.

FIG. 7B is an interferometric image demonstrating that the unrestrained non-planarity of 3.65 micrometers of the slide of FIG. 7A was reduced to 1.76 micrometers using the disclosed slide stage.

FIG. 8A is an interferometric image demonstrating the deviation from planarity estimated to be 30-40 micrometers for a substantially warped slide in an unrestrained/uncompressed state.

FIG. 8B is an interferometric image demonstrating that the unrestrained non-planarity estimated to be 30-40 micrometers for the slide of FIG. 8A was reduced to 6.98 micrometers using the disclosed slide stage.

Like reference symbols in the various drawings indicate like elements.

### DETAILED DESCRIPTION

The new sample slide stages and methods use at least four, and more preferably six or more, fixed members that are arranged at or at about the focal plane of the slide stage, and a set of corresponding compression members. The new slide stages are arranged such that the compression members are adjusted to apply a controlled force to a surface of a non-planar slide to not only securely hold the slide against the corresponding fixed members on the opposite side of the slide, but also to deform the non-planar slide from a twisted or bowed state toward the focal plane without cracking the slide. The new slide stages and methods thus can be used in standard slide scanning systems, such as DNA microarray or gene chip microarray scanners, to improve uniformity in scanning of slides in an effective and economical manner. For example, the new sample slide stages and methods can be used as the sample stages in the scanning systems described in U.S. Pat. Nos. 6,555,802 and 6,628,385, which are incorporated herein by reference in their entireties.

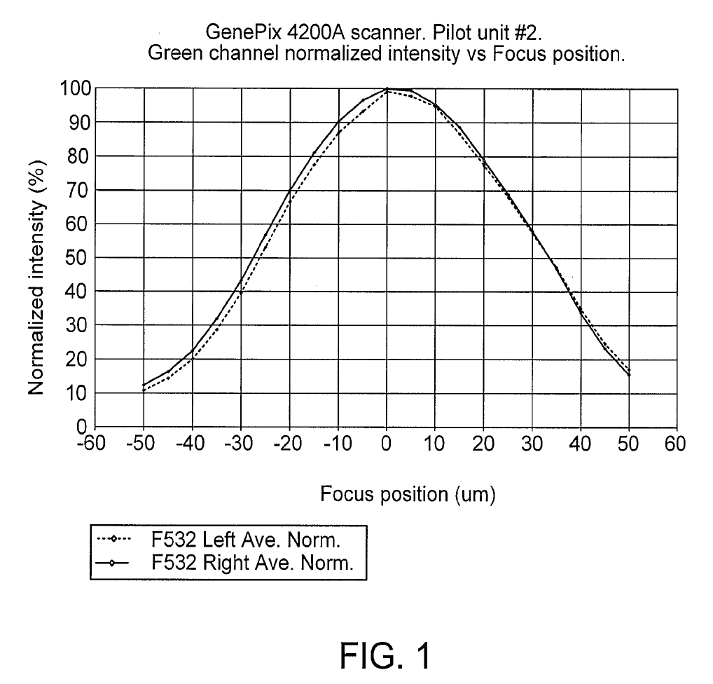

As used herein, a “non-planar” slide has a sample surface that, if uncorrected, deviates from the focal plane of the scanning apparatus so as to lead to non-uniformity or variation in emission intensity vs. scan position, for example as shown in the graph of FIG. 1. The amount of deviation from planarity that leads to detectable non-uniformity can depend on, for example, detector sensitivity, resolution, effective depth of focus, wavelength of light, variations in thickness of the sample being imaged, and the like. For example, the graph in FIG. 1 shows that a deviation from the focal plane of less than one micrometer can lead to some measurable non-uniformity in that particular instrument, and thus, deformation of a non-planar slide towards the focal plane by less than one micrometer can lead to a measurable improvement. It is not necessary that a non-planar slide be made perfectly planar, only that a surface of a non-planar slide be made more planar (deformed from its uncompressed state towards the focal plane) so as to lead to a measurable improvement in uniformity. The ability of the apparatus to correct a deviation from planarity depends on the mechanical properties of the slide, with flexible slides such as those made of plastic typically being relatively more deformable than slides made of stiffer or more brittle materials such as glass, silicon wafers, and the like.

Thus, as used herein, a non-planar slide has a sample surface that deviates from the focal plane of the apparatus by at least about 1 micrometer and generally at least about 5 micrometers. Typically, commercially available glass or quartz slides sold as “optically flat” deviate from the focal plane of the scanning apparatus on the order of tens of microns. Thus, in some embodiments, a non-planar slide deviates from the focal plan between about 5 and about 100 micrometers, or typically between about 10 micrometers and about 50 micrometers.

### Uniform Scanning Slide Stages

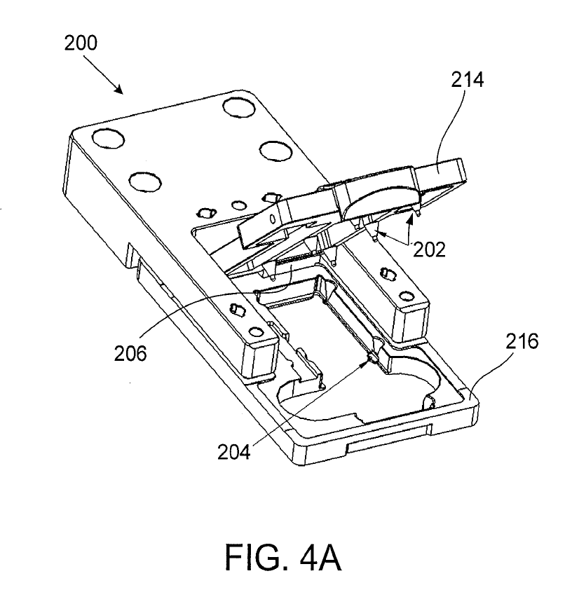

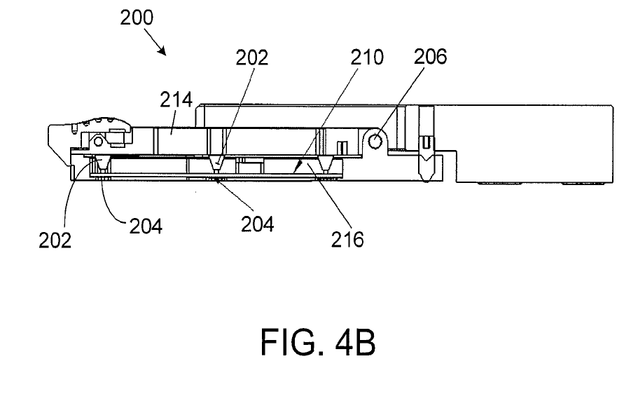

FIG. 4A is a perspective drawing of a slide stage 200, which includes at least four fixed members 204 at a focal plane that are configured to receive a slide 210 (shown in FIG. 4B); and a plurality of compression members 202, here six members, that compress a slide 210 towards the six fixed members 204 at the focal plane, whereby a surface of a non-planar slide 210 in the sample stage 200 is deformed towards the focal plane 208. The fixed members 204 are arranged in a rigid support frame 216 (shown as a lower frame in the embodiment of in FIG. 4A) and are aligned to within about 1 or 2 μm of the focal plane during manufacture or in subsequent testing.

These members 204 are called “fixed,” because they do not generally include a compression element and are not moved once arranged and/or adjusted during manufacture and testing. The fixed members can all be aligned with the focal plane during manufacture as one unit on support frame 216, or they can be adjustable and aligned after manufacture during testing and/or quality control. For example, one or more of the fixed members 204 (e.g., one of a total of four members, or three of a total of six members) can be rigidly secured to support frame 216 and the remainder can be adjustably secured to frame 216. Then during testing of the slide stage 200, the adjustable fixed members are adjusted, e.g., during a test scan, to ensure that all are aligned to within a set tolerance, e.g., 1 to 2 μm, of the focal plane.

In general, compression members 202 are distributed on a rigid support frame 214 (shown as the upper frame in the embodiment of FIG. 4A), which operates together with support frame 216 to define a slide receiver in sample stage 200 that opens to receive a slide and closes to compress a slide. Typically, the support frames 214 and 216 are hinged together, e.g., at hinge 206. The compression members 202 are arranged on the support frame 214 in a distribution that provides the best compression of the slide to bring it into conformance with the focal plane. For example, we have discovered that at least six compression members 202 (and six corresponding fixed members 204) are required to successfully correct the most common types of non-planar slides, i.e., the “bowed” and “twisted” defects. At least four pairs of compression/fixed members can be used to compress a twisted slide to some useful benefit, but cannot adequately address the “bowed” defect.

Each compression member 202 comprises a spring, an elastic bumper, an electromagnetic actuator, a piezoelectric actuator, a worm drive, a stepper motor, a solenoid, a magnetic actuator, a pneumatic actuator or a hydraulic actuator. Typically, each compression member 202 comprises a spring. Such compression members 202 can apply a compressing force of at least about 2 Newtons, or more typically, from between about 2 Newtons and about 7 Newtons.

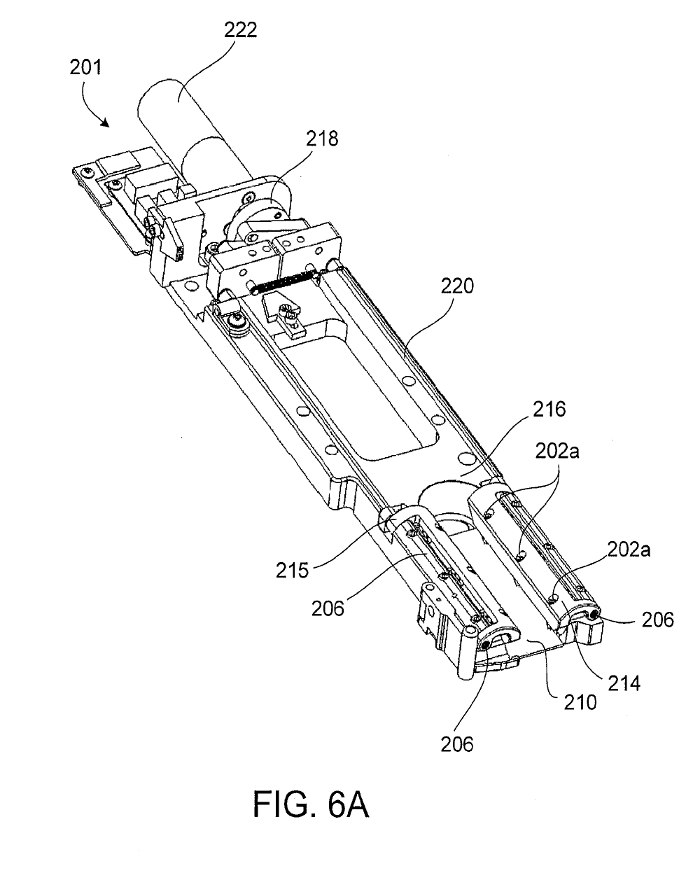

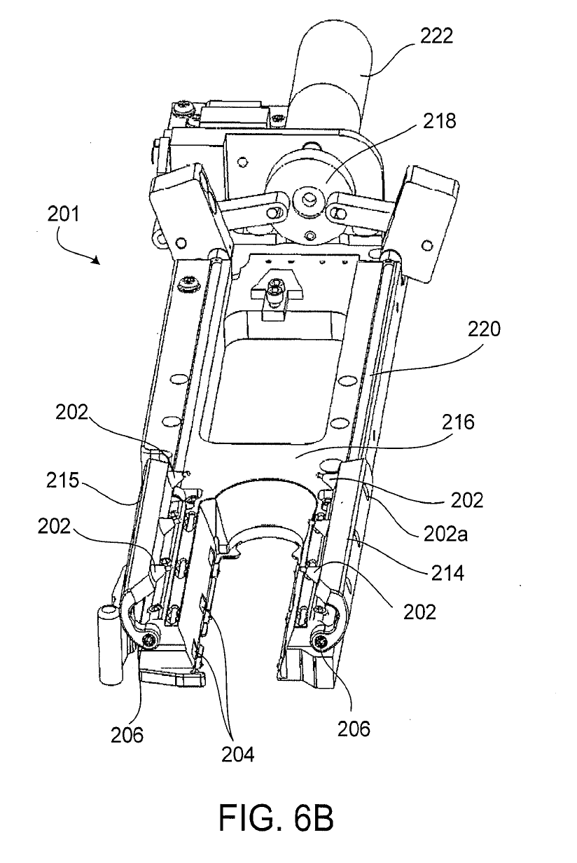

These compression forces are carefully controlled during testing of the slide stage after manufacture to ensure that the slide stage can successfully compress a non-planar slide to within a tolerance of about 1 to 2 μm (or up to about 5 μm) of the focal plane. In particular, all or most of the compression members 202 include an adjustment element 202a (not seen in FIG. 4A, but shown in FIG. 6A), such as a set screw, that is adjusted once the slide stage is manufactured during a test scan to ensure that each compression member applies the correct force to the surface of a non-planar slide to bring the slide into alignment with the focal plane, but without cracking the slide. These adjustment members are not to be adjusted by the consumer, and can be covered by a label or seal with a warning to the consumer to avoid changing the settings.

FIG. 4B is a side view of sample stage 200 of FIG. 4A, which shows the compression members 202 aligned with fixed members 204 on the top and bottom, respectively, of slide 210.

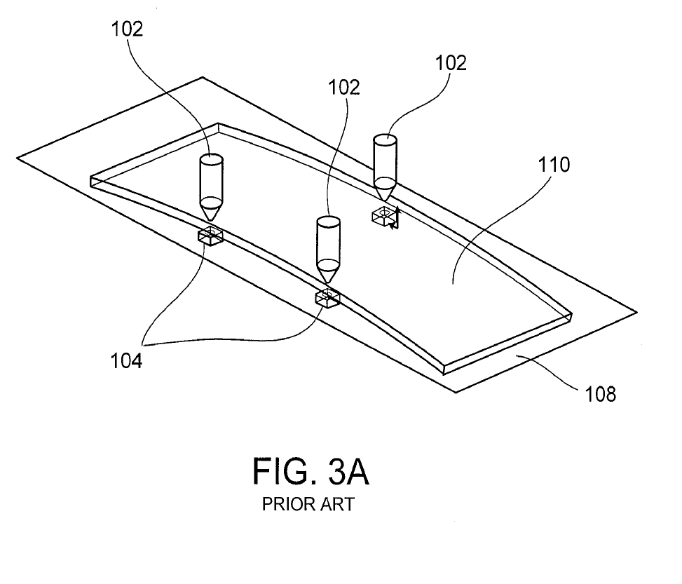

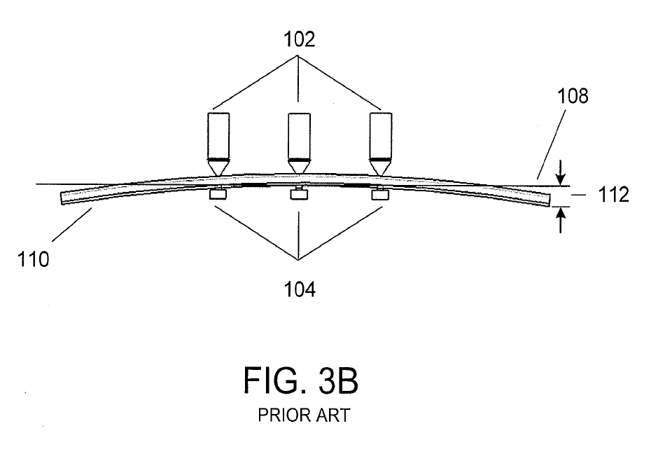

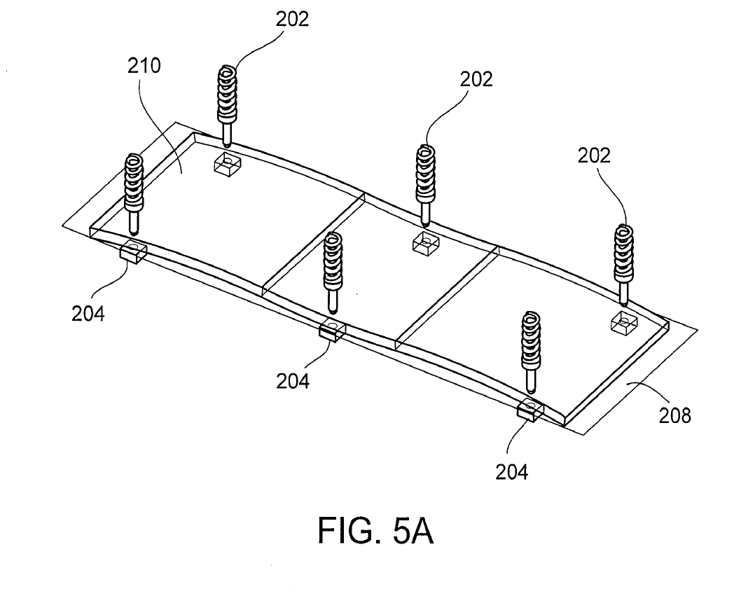

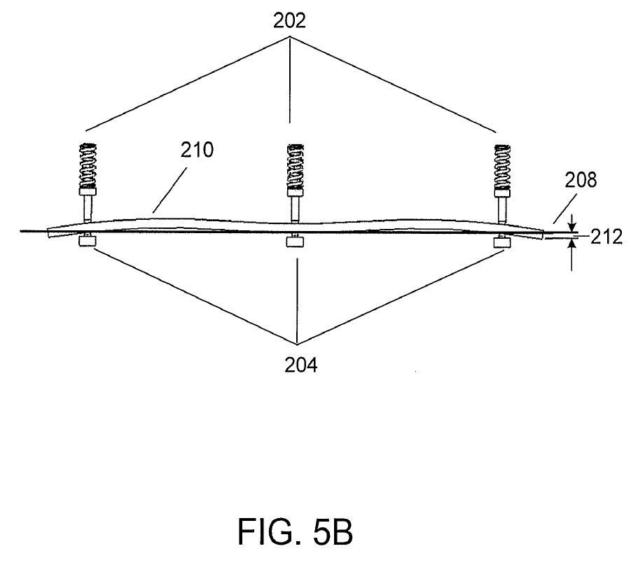

FIG. 5A is a perspective drawing of certain elements of slide stage 200. A non-planar slide 210 is held between compression members 202 and fixed members 204, thus deforming non-planar slide 210 towards focal plane 208. FIG. 5B is a side view of FIG. 5A. A slide 210 is held between compression members 202 and fixed members 204, thus deforming non-planar slide 210 towards focal plane 208. The deviation 212 between focal plane 208 and compressed slide 210 is reduced compared to deviation 112 in FIG. 3B, which illustrates a prior art method of securing a “bowed” slide.

FIG. 6A is a perspective drawing of a sample stage 201, similar to sample stage 200, but configured as a slide feeder drawer that compresses a slide 210 between compression members 202 and fixed members 204. While FIG. 6A shows slide stage 201 in a closed position (securing slide 210), FIG. 6B is a perspective view of sample stage 201, in which rigid support frame 214 and rigid support frame 215 are in an open configuration, pivoted about hinges 206, and the slide has been removed.

In the embodiment shown in FIGS. 6A and B, a first rigid support frame 216 (lower frame in this embodiment) includes six fixed members 204, and is secured via hinges 206 to second support frame 214 third rigid support frame 215, which each include three compression members 202. Each fixed member 204 is opposed at a slide 210 compressed in the slide receiver by one corresponding spring-loaded compression member 202.

FIGS. 6A and B also show a cam mechanism 218 and drive rods 220 (shown in FIG. 6B), which cause second support frame 214 and third support frame 215 to close by pivoting about hinges 206. Cam mechanism 218 can be coupled to operate as part of a drawer mechanism so that a slide is clamped into sample stage 201 as a drawer including sample stage 201 is closed. Such a slide feeder drawer can be automated using a motor 222.

In the various embodiments of the new slide stages, each fixed member 204 has a contact surface area at the focal plane of less than about 1 square millimeter. Typically, each fixed member 204 is a point contact or a ball contact. In various embodiments, the sample stage 200 or 201 includes between four and thirty fixed members 204, or in some embodiments between six and eight fixed members 204. In certain embodiments, one or more of the fixed members 204 is adjustable with respect to the focal plane 208. Typically, all or a group of the fixed members 204 are independently adjustable. As noted, by “fixed” is meant that fixed members 204 are typically not moved once adjusted to meet focal plane 208, in contrast to compression members 202, which move to apply a specific force to the surface of the slide to deform the slide into alignment, or closer alignment, with the focal plane.

In general, the new slide stages include a number of compression members 202 equal to the number of fixed members 204, but that is not required. Thus, each compression member 202 can be, but need not be, in axial alignment with a fixed member 204. While many embodiments include an equal number of fixed members and compression members, it is possible to have embodiments in which there are at least four fixed members and more than four compression members, as long as the overall arrangement provides the desired corrective deformation of a non-planar slide toward alignment with the focal plane of the slide stage, without cracking the slide.

The sample stage 200 or 201 can be configured to receive typical microscope slides 210. For example, the sample stage can be configured to receive a slide having dimensions of about 25 millimeters wide by about 75 millimeters long by about 0.7 millimeters to about 1.4 millimeters thick. In some embodiments, a surface of a non-planar slide 210 can be deformed towards the focal plane by at least about 1 micrometer, at least about 5 micrometers, at least about 10 micrometers, or at least about 15 micrometers.

In some embodiments, a slide stage includes a first rigid support having at least six fixed members at a focal plane, wherein each fixed member is a point contact or a ball contact. Also included is a second rigid support and a third rigid support, each hinged to the first support, the hinged rigid supports together defining a slide receiver that opens to receive a slide and closes to compress a slide. Further, for each fixed member, a corresponding spring-loaded compression member is located at the second rigid support or the third rigid support so that each fixed member is opposed at a slide compressed in the slide receiver by one corresponding spring-loaded compression member. Thus, a surface of a non-planar slide is deformed towards the focal plane. In various embodiments, the slide stage is included within a microarray scanner, e.g., a DNA microarray scanner.

### Methods of Deforming Non-Planar Slides

The new slide stages are used in methods of deforming sample slides to align with, or come into closer alignment with, a focal plane. These methods include inserting a non-planar slide into a slide stage, e.g., as described herein, the slide stage having at least four fixed members arranged at about a focal plane (e.g., within 1, 2, 3, 4, or 5 micrometers of the focal plane), and then compressing the non-planar slide to the fixed members, whereby a surface of the non-planar slide is deformed towards the focal plane. In various embodiments, the slide stage employed in these methods is as described herein.

In various embodiments, the force of the compressing step is applied with a compression member that can be or include a spring, an elastic bumper, an electromagnetic actuator, a piezoelectric actuator, a worm drive, a stepper motor, a solenoid, a magnetic actuator, a pneumatic actuator or a hydraulic actuator. In certain embodiments, the force of the compressing step is applied with a spring. In various embodiments, the methods include the use of 4, 6, 8, or more pairs of compression/fixed members, e.g., at least 6 pairs of members.

Some embodiments include a step of adjusting one or more of the fixed members with respect to the focal plane. In certain embodiments, the force is applied to the slide at locations opposite to at least one of the fixed members, typically at locations opposite to each of the fixed members. In some embodiments, one or more of the compression members are adjusted to control the force applied to the slide. In various embodiments, the compressing step applies a force of at least about 2 Newtons, or more typically, between about 2 Newtons to about 7 Newtons.

In various embodiments of the methods of deforming a slide to a focal plane, a surface of a non-planar slide is deformed towards the focal plane by at least about 1 micrometer, at least about 5 micrometers, at least about 10 micrometers, or at least about 15 micrometers.

### EXAMPLES

The invention is further described in the following examples, which do not limit the scope of the invention described in the claims.

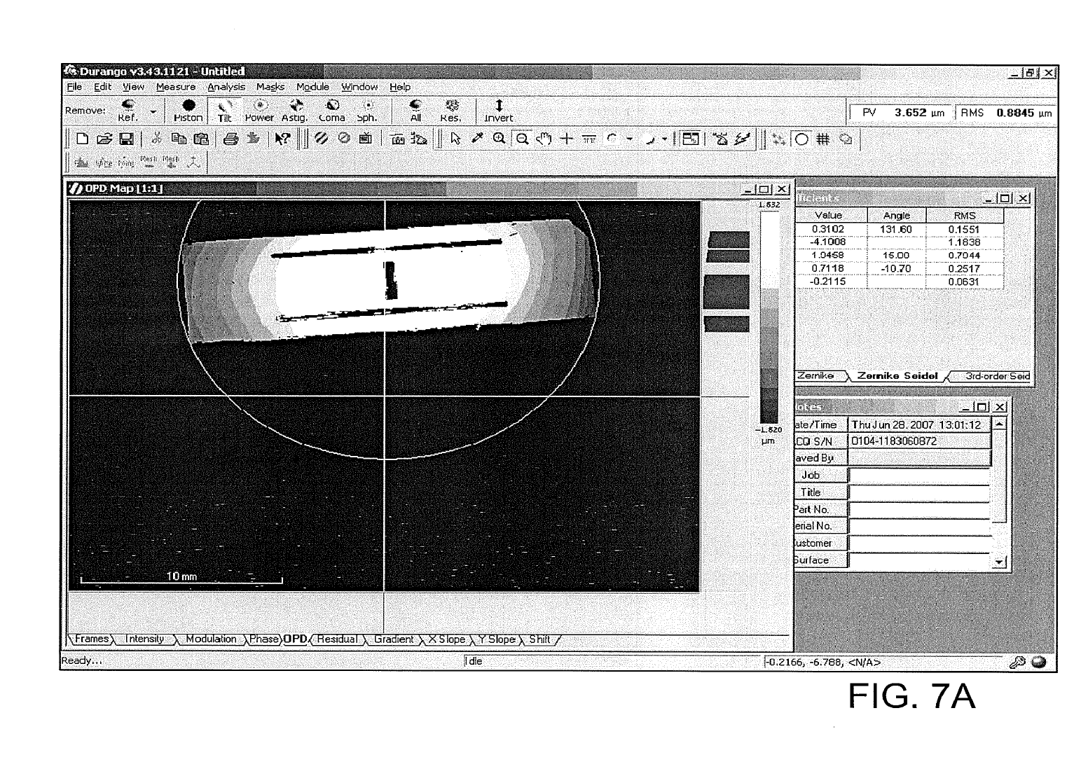

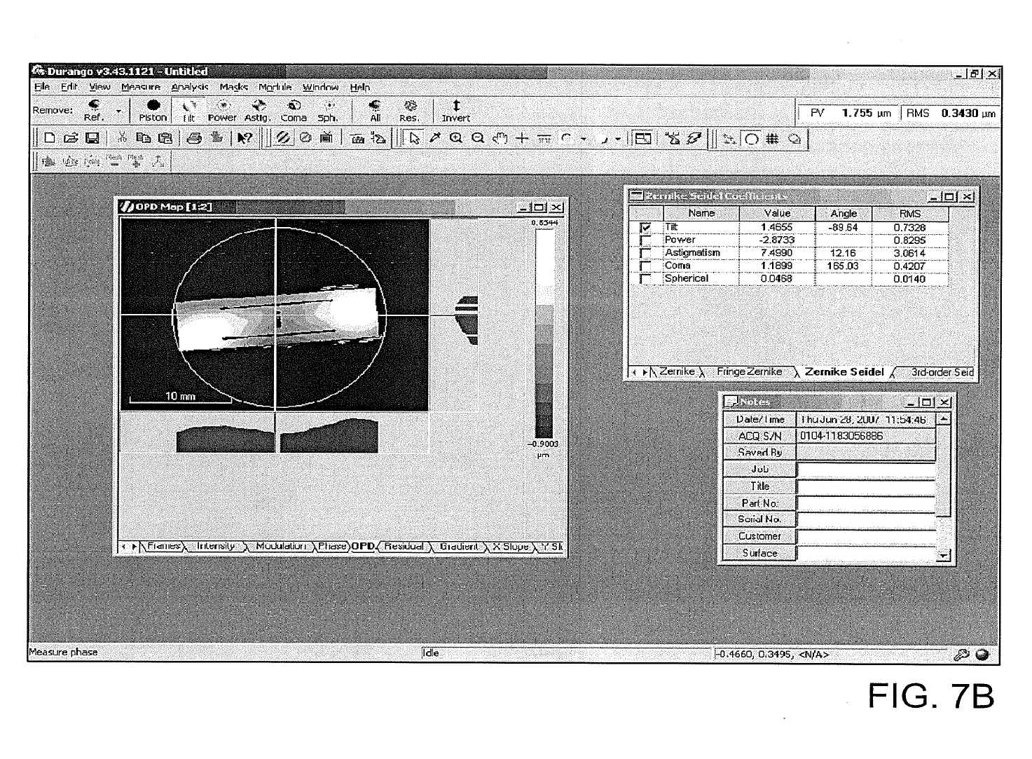

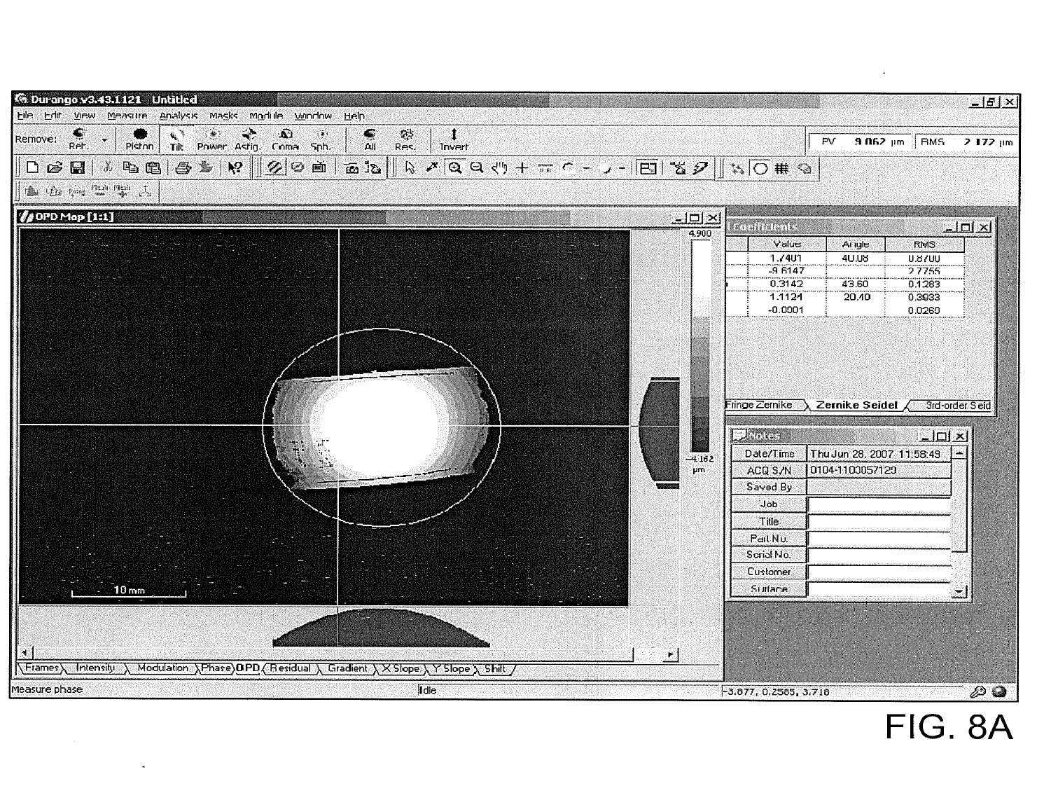

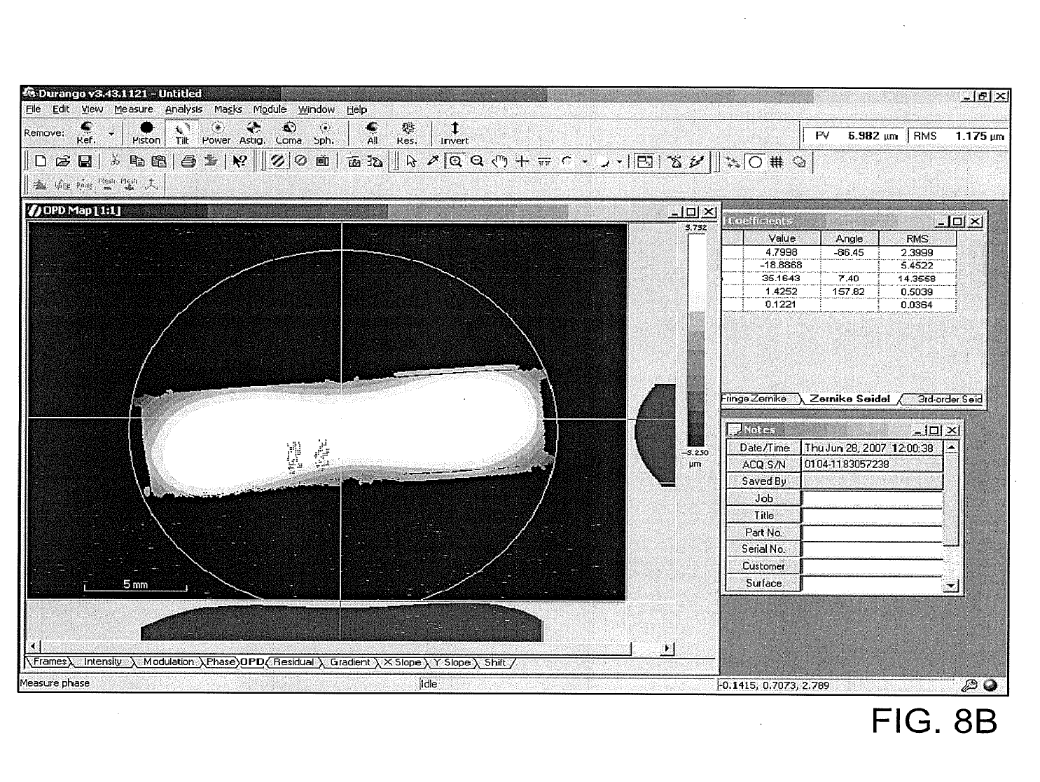

FIGS. 7A to 8B demonstrate non-planarity of slides and corresponding deformation of such non-planar slides towards the focal plane as accomplished by an example of the new slide stages described herein. Finite element analysis was used to predict that the non-planar aspect of the slide could be reduced as much as 3-4 times with this method, which was then verified by testing.

### Example 1

FIG. 7A shows the deviation from planarity of an unrestrained/uncompressed non-planar slide as measured by interferometry. Resulting peak-to-valley (PV) non-planarity was measured at 3.65 micrometers.

FIG. 7B, by contrast, shows the same non-planar slide as positioned in the six-point slide stage 201 depicted in FIGS. 6A and 6B. On compression in six-point slide stage 201, interferometry showed that the unrestrained non-planarity of 3.65 micrometers of the slide was reduced to 1.76 micrometers. This deformation towards the focal plane is sufficient to lead to a measurable improvement in focus and uniformity.

### Example 2

FIG. 8A shows the deviation from planarity of a substantially non-planar (warped) slide as measured by interferometry in an unrestrained/uncompressed state. The peak-to-valley (PV) non-planarity was estimated to be 30-40 micrometers. Interferometry was not capable of measuring planarity along the long side of the slide, because of the very high density of the interference fringes. The central part of the slide (½ of the length) was measured to be non-planar by about 9 micrometers.

FIG. 8B, by contrast, shows the same non-planar slide as positioned in the six-point slide stage 201 depicted in FIGS. 6A and 6B. On compression in six-point slide stage 201, interferometry showed that the estimated unrestrained non-planarity of 30-40 micrometers was reduced to 6.98 micrometers for the entire slide. This deformation towards the focal plane led to a substantial improvement in focus and uniformity.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A slide stage, comprising:
at least four fixed members arranged at about a focal plane of the stage and configured to receive a slide; and
a plurality of at least about four compression members that are arranged to apply a controlled force to a surface of a slide towards the fixed members at the focal plane,
whereby a surface of a non-planar slide in the slide stage is deformed towards the focal plane.

2. The slide stage of claim 1, wherein each compression member applies a controlled force of at least about 2 to about 7 Newtons.

3. The slide stage of claim 1, wherein each compression member comprises a spring, an elastic bumper, an electromagnetic actuator, a piezoelectric actuator, a worm drive, a stepper motor, a solenoid, a magnetic actuator, a pneumatic actuator, or a hydraulic actuator.

4. The slide stage of claim 1, wherein each compression member comprises a spring.

5. The slide stage of claim 1, further comprising first and second rigid support frames, wherein the fixed members are arranged on the first support frame and the compression members are arranged on the second support frame, and wherein the first and second rigid support frames are arranged to operate together to define a slide receiver in the slide stage that opens to receive a slide and closes to compress a slide.

6. The slide stage of claim 5, wherein the first and second support frames are hinged together.

7. The slide stage of claim 1, further comprising first, second, and third rigid support frames, wherein the fixed members are arranged on the first support frame and groups of the compression members are arranged on the second and third support frames, and wherein the second and third rigid support frames are arranged to operate together with the first support frame to define a slide receiver in the slide stage that opens to receive a slide and closes to compress a slide.

8. The slide stage of claim 7, wherein the second and third support frames are each hinged to the first support frame.

9. The slide stage of claim 1, wherein each fixed member is axially aligned with one corresponding spring-loaded compression member.

10. The slide stage of claim 10, comprising between six and eight fixed members.

11. The slide stage of claim 10, wherein one or more of the fixed members are adjustable with respect to the focal plane.

12. The slide stage of claim 1, wherein the compression members are arranged to apply a controlled force that deforms a surface of a non-planar slide towards the focal plane by at least about 5 micrometers.

13. A method of deforming a non-planar slide towards a focal plane, the method comprising:
inserting a non-planar slide into a slide stage comprising at least four fixed members that are arranged at about a focal plane of the slide stage; and
applying a controlled force to at least four points on a surface of the non-planar slide to compress the slide towards the fixed members at the focal plane, whereby a surface of the non-planar slide is deformed towards the focal plane.

14. The method of claim 13, wherein a controlled force of at least about 2 to 7 Newtons is applied.

15. The method of claim 13, wherein the controlled force is applied with a spring, an elastic bumper, an electromagnetic actuator, a piezoelectric actuator, a worm drive, a stepper motor, a solenoid, a magnetic actuator, a pneumatic actuator, or a hydraulic actuator.

16. The method of claim 13, wherein the sample stage comprises between six and eight fixed members.

17. The method of claim 13, further comprising adjusting one or more of the fixed members with respect to the focal plane.

18. A scanning system comprising a slide stage of claim 1.

19. The scanning system of claim 18, wherein the system is a microarray scanner.
